(19) United States
(12) Patent Application Publication
(10) Pub. No.: US 2019/0337607 A1
(43) Pub. Date: Nov. 7, 2019

(54) DRONE USING COAXIAL INVERTED ROTOR

(71) Applicants: LG ELECTRONICS INC., Seoul (KR); INDUSTRY-UNIVERSITY COOPERATION FOUNDATION KOREA AEROSPACE UNIVERSITY, Goyang-si, Gyeonggi-do (KR)

(72) Inventors: Kunwoo LEE, Seoul (KR); Yongkyu SONG, Goyang-si (KR); Jeongho NOH, Seoul (KR); Junseok BANG, Seoul (KR); Chulbae LEE, Seoul (KR)

(73) Assignees: LG ELECTRONICS INC., Seoul (KR); INDUSTRY-UNIVERSITY COOPERATION FOUNDATION KOREA AEROSPACE UNIVERSITY, Goyang-si, Gyeonggi-do (KR)

(21) Appl. No.: 16/481,429

(22) PCT Filed: Jan. 26, 2017
(86) PCT No.: PCT/KR2017/000983

§ 371 Date: Jul. 26, 2019

(30) Foreign Application Priority Data
Jan. 26, 2017 (KR) 10-2017-0012511

(51) Int. Cl. B64C 11/48; B64C 27/10; B64C 27/12; B64C 39/02

(52) U.S. Cl. CPC B64C 11/48; B64C 27/10; B64C 27/12; B64C 39/024; B64C 2201/165; B64C 2201/042; B64C 2201/108; B64C 2201/14; B64C 2201/024

(57) ABSTRACT

A rotary wing drone according to one embodiment of the present invention comprises: a flight control unit for controlling the flight of the rotary wing drone; a main body including a first motor and a second motor; an upper shaft vertically inserted into the main body and rotating in a first direction around a first axis by means of the force of the first motor; a plurality of upper rotor blades connected to the upper shaft such that the plurality of upper rotor blades rotate in the first direction around the first axis at a fixed pitch angle; a lower shaft vertically inserted into the main body and rotating in a second direction opposite to the first direction around the first axis by means of the force of the second motor; a plurality of lower rotor blades and a swash plate connected to the lower shaft so as to rotate in the second direction around the first axis and having a variable pitch angle; a slope regulator for regulating the slope of the swash plate; a link part for connecting the swash plate to the plurality of lower rotor blades; and a pitch control unit positioned at the lower ends of the plurality of lower rotor blades.

### TECHNICAL FIELD

The present disclosure relates to a rotary wing drone using a coaxial inverted rotor.

### BACKGROUND ART

Recently, the number of drones that can be operated by an individual or a company is increasing. Drone refers to a flying vehicle on which a person does not ride, but which travels under a control signal of a wireless radio wave.

The drones may be divided into a rotary wing drone, a fixed wing drone, and a tilt rotor drone depending on whether a wing is rotatable.

The fixed wing drone is a flying vehicle which flies with a fixed wing to a fuselage and lifts using an engine or a propeller. The fixed wing drone may have long flight time or distance, and may have high altitude flight and have a high speed, so that the fixed wing drone is mainly used for military purposes.

The rotary wing drone is a flying vehicle that lifts when a propeller mounted on a rotary shaft rotates. The rotary wing drone is easily controlled, so that it is widely used in the field of broadcasting and transportation of goods.

The tilt rotor drone is a flying vehicle that employs the fixed wing and rotary wing schemes. The till rotor drone is capable of vertical takeoff or high-speed forward flight by rotating an engine and a propeller at each of both ends of the wing.

In recent years, the rotary wing drone which is easily controlled is widely used with development of industry.

The rotary wing drone uses rotation of rotor blades to generate lift and fly. When the rotor blade rotates within a horizontal plane at an appropriate pitch angle, the lift may be generated. When the pitch angle is controlled to increase or decrease the lift to achieve the balance and motion in the vertical direction. In this connection, in the rotation of the rotor blade, air resistance may occur due to the principle of action-reaction. This causes a problem that the vehicle rotates in a direction opposite to the rotation direction of the rotor blade due to the reaction torque as generated due to the air resistance. Various types of rotary wing drones have emerged to cancel this reaction torque.

First, how to cancel the reaction torque will be described with reference to some types of helicopters by way of example.

In a single rotor helicopter, the reaction torque is counteracted using a configuration that a small tail rotor blade is mounted on a tail of a flying vehicle in a substantially perpendicular to a rotation surface of a main rotor.

In a tandem rotor helicopter, the reaction torque is counteracted using a configuration that rotor blades, which rotate in opposite directions are disposed at front and rear ends of the flying vehicle, respectively.

In a coaxial inverted rotor helicopter, the reaction torque is counteracted using a configuration that an upper rotor blade and a lower rotor blade that rotate in opposite directions in the same rotation axis center are disposed.

As described above, the helicopter cancels the reaction torque with the various schemes. Thus, the rotary wing drones to counteract the reaction torque using the principles of the helicopters as described above have recently emerged recently.

In particular, recently, a multi-copter, in particular, a quad-copter has been popular in which a plurality of rotors, which are easily controlled and are relatively simple in terms of a structure, rotate around different axes, to generate lift. However, a rotary wing drone based on a principle of a coaxial inverted rotor helicopter can generate a larger lift than a multi-copter having the same size can generate, and may be more stable than the latter and may be less noisy than the latter.

However, the rotary wing drone using the coaxial inverted rotor, which is currently being commercialized directly uses a very complicated structure of the coaxial inverted rotor helicopter. In this case, there is a problem that the maintenance work thereof itself is difficult and the maintenance cost is high.

Therefore, there is a need for a rotary wing drone using a coaxial inverted rotor with a simple structure while generating a larger lift than a multi-copter can generate.

### DISCLOSURE

### Technical Purposes

A purpose of the present disclosure is to solve the above-mentioned problems and other problems. A purpose of one embodiment of the present disclosure is to simplify a structure of a rotary wing drone using a coaxial inverted rotor by eliminating unnecessary structures in the rotary wing drone using the coaxial inverted rotor.

Further, another purpose of the present disclosure is to provide a new control method of flight of a rotary wing drone.

The technical purpose to be achieved in accordance with the present disclosure are not limited to the technical purposes as mentioned above. Other technical purposes as not mentioned may be clearly understood by those skilled in the art to which the present disclosure belongs from the following descriptions.

### Technical Solutions

In one aspect of the present disclosure, there is provided a rotary wing drone comprising: a flight controller configured to control flight of the rotary wing drone; a main body for receiving a first motor and a second motor therein; an upper shaft vertically inserted into the main body, wherein the upper shaft rotates in a first direction about a first axis using a rotation force from the first motor; a plurality of upper rotor blades coupled to the upper shaft to rotate in the first direction about the first axis at a fixed pitch angle; a lower shaft vertically inserted into the main body, wherein the lower shaft rotates in a second direction opposite to the first direction about the first axis using a rotation force from the second motor; a plurality of lower rotor blades coupled the lower shaft to rotate in the second direction about the first axis at a varying pitch angle; and a pitch control mechanism including a swash plate, a tilt adjuster for adjusting a tilt of the swash plate, and linkages for connecting the swash plate and the plurality of lower rotor blades with each other respectively, wherein the pitch control mechanism is disposed below the lower rotor blades.

The technical solution that may be obtained from the present disclosure is not limited to the solutions as mentioned above. Other solutions as not mentioned may be clearly understood by those of ordinary skill in the art to which the present disclosure belongs from the descriptions below.

### Technical Effects

The effects of the present disclosure is as follows.

At least one of the embodiments of the present disclosure has the advantage that the structure of the rotary wing drone is simplified.

Further, at least one of the embodiments of the present disclosure has the effect of reducing the noise of the rotary wing drone.

Further, according to at least one of the embodiments of the present disclosure, there is an advantage that the maintenance work of the rotary wing drone using the coaxial inverted rotor is easy and the maintenance cost is low from the point of view of the user.

The effects that may be obtained from the present disclosure are not limited to the effects as mentioned above. Other effects as not mentioned may be clearly understood by those skilled in the art to which the present disclosure belongs from the following descriptions.

### BRIEF DESCRIPTION OF THE DRAWINGS

FIG. 1 is a block diagram to describe the rotary wing drone 100 associated with the present disclosure.

FIG. 2 shows an appearance of a rotary wing drone according to one embodiment of the present disclosure.

FIG. 3 shows an internal structure of a front face of the rotary wing drone.

FIG. 4 shows an internal structure of a back face of the rotary wing drone.

FIG. 5 is an illustration of one example of a method by which a motor delivers torque to upper and lower shafts in a rotary wing drone according to one embodiment of the present disclosure.

FIG. 6 is an illustration of another example of how a motor delivers torque to an upper shaft and a lower shaft in a rotary wing drone according to one embodiment of the present disclosure.

FIG. 7 is a table for describing one example of how to control a first motor and second motor and adjust a tilt of a swash plate according to a flight command in a rotary wing drone according to one embodiment of the present disclosure.

FIG. 8 is a table describing another example of how to control a first motor and second motor and adjust a tilt of a swash plate according to a flight command in a rotary wing drone according to one embodiment of the present disclosure.

FIG. 9 is a table describing another example of how to control a first motor and second motor and adjust a tilt of a swash plate according to a flight command in a rotary wing drone according to one embodiment of the present disclosure.

FIG. 10 is an illustration of one example of how to adjust a pitch angle of a plurality of lower rotor blades using a pitch control mechanism in a rotary wing drone according to one embodiment of the present disclosure.

FIG. 11 to FIG. 14 illustrate one example of a method for controlling a tilt adjuster and thus controlling a tilt of a swash plate according to a forward, rearward, or sideward flight command in a rotary wing drone according to one embodiment of the present disclosure

FIG. 15 illustrates one example where a top cover performs a switch function in a rotary wing drone according to one embodiment of the present disclosure.

### DETAILED DESCRIPTIONS

Examples of various embodiments are illustrated and described further below. The same reference numbers in different figures denote the same or similar elements, and as such perform similar functionality. Further, descriptions and details of well-known steps and elements are omitted for simplicity of the description. Suffixes “module” and “unit” for components used in the following description are to be given or mixed with other only in consideration of ease of drafting of the present disclosure, and may have the same meaning or role by itself. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Further, the accompanying drawings are included to provide easy understanding of the embodiments disclosed herein. The technical idea or scope as disclosed in the present specification is not limited to the attached drawings. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the singular forms “a” and “an” are intended to include the plural forms as well, unless the context clearly indicates otherwise.

It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

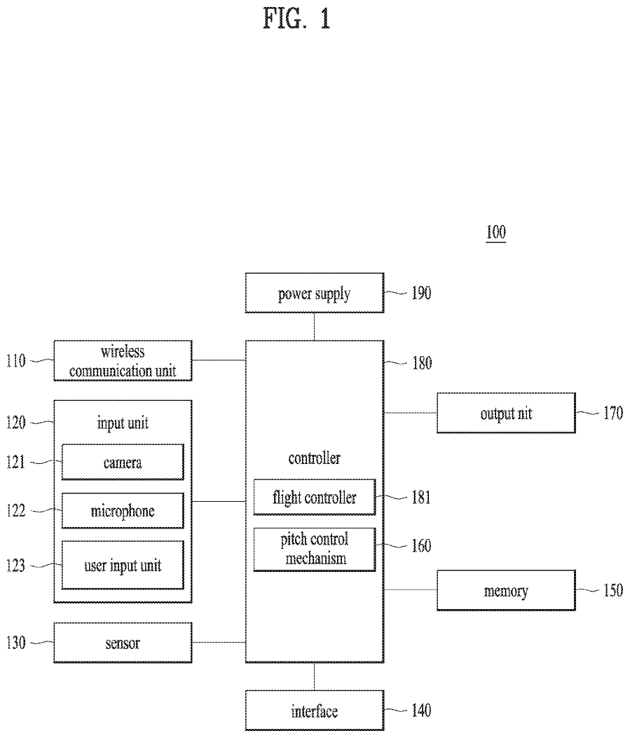

FIG. 1 is a block diagram to describe the rotary wing drone 100 associated with the present disclosure.

The rotary wing drone 100 may include a wireless communication unit 110, an input unit 120, a sensor 130, an interface 140, a memory 150, a controller 180, and a power supply 190. The components shown in FIG. 1 may not be essential to implement the rotary wing drone 100. The rotary wing drone 100 as described herein may have components that are more or less than the components as listed above.

More specifically, the wireless communication unit 110 of the components may include one or more modules that enable wireless communication between the rotary wing drone 100 and the wireless communication system, or wireless communication between the rotary wing drone 100 and a control device the rotary wing drone 100, or wireless communication between the rotary wing drone 100 and an external server. Further, the wireless communication unit 110 may include one or more modules that connect the rotary wing drone 100 to one or more networks.

The wireless communication unit 110 may include a mobile communication module wireless Internet module, a short-range communication module, and a position information module.

The mobile communication module transmits and receives radio signals with at least one of the base station, the control device of the rotary wing drone 100 and the server over a mobile communication network constructed according to technical standards or communication schemes for mobile communication (for example, GSM(Global System for Mobile communication), CDMA(Code Division Multi Access), CDMA2000(Code Division Multi Access 2000), EV-DO(Enhanced Voice-Data Optimized or Enhanced Voice-Data Only), WCDMA(Wideband CDMA), HSDPA(High Speed Downlink Packet Access), HSUPA(High Speed Uplink Packet Access), LTE(Long Term Evolution), LTE-A(Long Term Evolution-Advanced), etc.)

The wireless Internet module refers to a module for wireless Internet access and may be embedded in or disposed on the rotary wing drone 100. The wireless Internet module is configured to send and receive radio signals over a communication network according to wireless Internet technologies.

Wireless Internet Technology may include, for example, WLAN(Wireless LAN), Wi-Fi(Wireless-Fidelity), Wi-Fi(Wireless Fidelity) Direct, DLNA(Digital Living Network Alliance), WiBro(Wireless Broadband), WiMAX(World Interoperability for Microwave Access), HSDPA(High Speed Downlink Packet Access), HSUPA(High Speed Uplink Packet Access), LTE(Long Term Evolution), LTE-A(Long Term Evolution-Advanced), etc. The wireless Internet module transmits and receives data according to at least one wireless Internet technology, including the Internet technologies as not listed in the above list.

From the viewpoint that the wireless Internet connection over WiBro, HSDPA, HSUPA, GSM, CDMA, WCDMA, LTE, LTE-A etc. is performed using the mobile communication network, the wireless Internet module that performs a wireless Internet connection using the mobile communication network may be understood as a type of the mobile communication module.

The short-range communication module is configured for short-range communication. The short-range communication module may support the short-range communication using at least one of Bluetooth™, RFID(Radio Frequency Identification), Infrared Data Association(IrDA), UWB(Ultra Wideband), ZigBee, NFC(Near Field Communication), Wi-Fi(Wireless-Fidelity), Wi-Fi Direct, Wireless USB(Wireless Universal Serial Bus), etc. This short-range communication module can support communication between the rotary wing drone 100 and the wireless communication system, and between the rotary wing drone 100 and the control device of the rotary wing drone 100 or wireless communication between the rotary wing drone 100 and the external server over Wireless Area Networks. The short-range wireless communication network or Wireless Area Networks may include a wireless personal area network.

In this connection, the control device of the rotary wing drone 100 may be a remote controller, a mobile terminal or portable device as well as a wearable device, for example, a smartwatch, smart glass, or HMD (head mounted display).

In one example, according to one embodiment of the present disclosure, the wireless communication unit 110 may receive a flight control command from an external device, for example, the control device of the rotary wing drone 100, a mobile terminal, and the like. The flight controller 181 may control the flight of the rotary wing drone 100 by controlling a pitch control mechanism 160 and a motor built into the rotary wing drone 100 according to the flight control command.

The position information module may include a module for acquiring a position or current position of the rotary wing drone 100. A representative example thereof may include a GPS (Global Positioning System) module or a WiFi (Wireless Fidelity) module. For example, when the mobile terminal utilizes a GPS module, the position of the rotary wing drone 100 can be obtained by the mobile terminal using the signal from the GPS satellite. Alternatively, or additionally, the position information module may perform a function of one of other modules of the wireless communication unit 110 to obtain data regarding the position of the rotary wing drone 100. The position information module is used to acquire the position or current position of the rotary wing drone 100 and is not limited to modules that directly calculate or acquire the position of the rotary wing drone 100.

The input unit 120 may include a camera 121 or an image input unit 120 for inputting an image signal, a microphone 122 or an audio input unit 120 for inputting an audio signal, and a user input unit 123 for receiving specific input from a user. The voice data or image data collected from the input unit 120 may be analyzed and processed as a control command.

The input unit 120 is configured for inputting image information or signal, audio information or signal, or information input from the user. The rotary wing drone 100 may have one or a plurality of cameras 121 for input of the image information.

The camera 121 processes an image frame such as a still image or a moving image obtained by an image sensor in the photographing mode. The processed image frame may be stored in memory 150. In one example, a plurality of cameras 121 provided in the rotary wing drone 100 may be arranged to form a matrix structure. A plurality of image information having various angles or foci obtained using the cameras 121 having the matrix structure may be input to the rotary wing drone 100. Further, the plurality of cameras 121 may be arranged in a stereo structure to acquire a left image and a right image to implement a stereoscopic image.

The microphone 122 converts the external sound signal to the electrical voice data. The processed voice data may be used to control the flight of the rotary wing drone 100. In one example, the microphone 122 may be implemented to have various noise reduction algorithms to remove noise as generated in a process for receiving an external sound signal.

The user input unit 123 is configured for receiving input from a user. When specific input is transmitted using the user input unit 123, the controller 180 may control the rotary wing drone 100 to operate in a corresponding manner to the input information. The user input unit 123 may be positioned as mechanical input means on the top cover of the rotary wing drone 100.

The sensor 130 may include one or more sensors for sensing at least one of the information about information about factors in the rotary wing drone 100 and information about the surrounding environment surrounding the rotary wing drone 100. For example, the sensor 130 may include at least one of an acceleration sensor, a magnetic sensor, a gravity sensor (G-sensor), a gyroscope sensor, a motion sensor, an infrared sensor, a battery gauge, an ultrasonic sensor, an environmental sensor, (e.g., barometer, hygrometer, thermometer, a radiation detection sensor, a thermal sensor, a gas sensing sensor), or an optical sensor. In one example, the rotary wing drone 100 disclosed herein may combine and utilize at least two information as sensed by at least two of these sensors.

Further, the controller 180 may recognize a flight attitude of the rotary wing drone 100 based on the sensed signal and stabilize the flight attitude.

Specifically, the controller 180 may use the sensor 130 to recognize whether the flight attitude of the rotary wing drone 100 is unstable. Then, the controller 180 may change the flight attitude of the rotary wing drone 100 so that the rotary wing drone 100 may fly at a stable attitude based on the recognized information.

The interface 140 serves as a channel with various types of external devices connected to the rotary wing drone 100. The interface 140 may include at least one of an external charger port, a wired/wireless data port, a memory card port, and a video output port.

The interface 140 may be act as a path through which power from an external cradle is supplied to the rotary wing drone 100 when the rotary wing drone 100 is connected to the external cradle.

The memory 150 stores data supporting various functions of the rotary wing drone 100. In particular, the memory 150 stores an algorithm that can recognize whether the flight attitude of the rotary wing drone 100 is a stable attitude or may store control instructions and programs that change the flight attitude of the rotary wing drone 100 to a stable attitude. These instructions and programs may exist in the memory 150 of the rotary wing drone 100 from the time of release of the rotary wing drone 100.

The memory 150 may include at least one type of storage medium such as a flash memory type, a hard disk type, an SSD type, a SDD type, a multimedia card micro-type 122, Random access memory (RAM), static random access memory (SRAM), read-only memory (ROM), electrically erasable programmable read-only memory (EEPROM), programmable read-only memory (PROM), a magnetic memory, a magnetic disk, and an optical disk.

The output unit 170 may include at least one of a sound output unit 170, a haptic module, and an optical output unit 170 for generating an output related to a visual or auditory or haptic sense or the like.

The sound output unit 170 may output the audio data stored in the memory 150. The sound output unit 170 outputs a sound signal related to a function performed in the rotary wing drone 100. The sound output unit 170 may include a receiver, a speaker, and a buzzer.

The haptic module generates various tactile effects that the user may feel. A typical example of a haptic effect generated by the haptic module may be vibration. An intensity and pattern of the vibrations as generated by the haptic module may be controlled by the user's choice or settings by the controller 180.

The optical output unit 170 outputs a signal for notifying occurrence of an event using light of a light source. Examples of the events that occur in the rotary wing drone 100 may include power ON/OFF, or an event when a residual battery level is lower than a predetermined amount, and so on.

The optical output unit 170 may be configured in a cylindrical shape on the top cover of the rotary wing drone 100 and may be implemented by emitting light of a single color or a plurality of colors. The light output from the optical output unit 170 may be output only for a predetermined time. The light output from the optical output unit 170 may continue to be output while the rotary wing drone 100 is powered on.

The controller 180 may include a flight controller 181 and a pitch control mechanism 160.

The flight controller 181 may control the flight of the rotary wing drone 100.

The pitch control mechanism 160 may control the cyclic pitch angle as the plurality of rotor blades of the rotary wing drone 100 rotate.

In one example, the controller 180 controls the overall operation of the rotary wing drone 100. The controller 180 processes the signals input and output using the components as discussed above or executes the instructions and programs stored in the memory 150, thereby to control the flight of the rotary wing drone 100.

Further, the controller 180 may individually control at least some of the components as illustrated in FIG. 1 to execute the instructions and programs stored in the memory 150 or may control combinations of two or more components together.

The power supply 190 receives power from an internal power supply under the control of the controller 180 and supplies the power to each component included in the rotary wing drone 100. This power supply 190 includes a battery. The battery may be an internal battery or a replaceable battery.

The battery may be a built-in battery that is chargeable or may be detachably coupled to a body of the rotary wing drone 100 for charging or the like the drone.

Further, the power supply may have a connection port. The connection port may be configured as an example of an interface to which an external charger supplying the power for charging the battery is electrically connected.

In another example, the power supply may be configured to charge the battery in a wireless scheme without using the connection port. In this case, the power supply may receive power from an external wireless power transmission apparatus using at least one of an inductive coupling scheme or a magnetic resonance coupling scheme based on an electromagnetic resonance phenomenon.

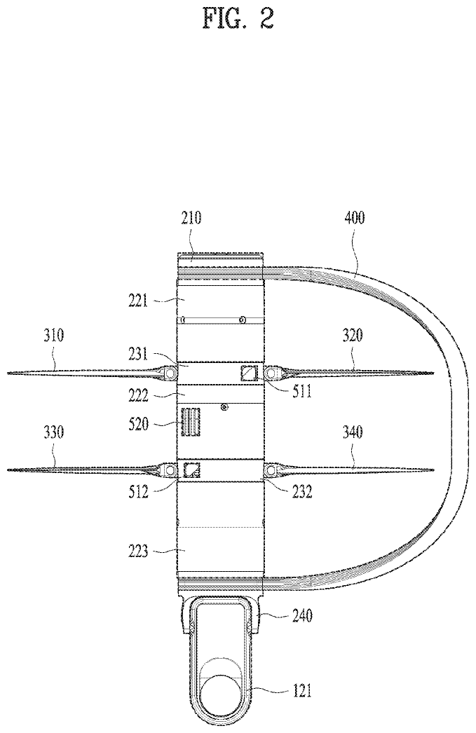

FIG. 2 shows an appearance of a rotary wing drone according to one embodiment of the present disclosure.

Referring to FIG. 2, the rotary wing drone 100 has a cylindrical body. However, the present disclosure is not limited thereto. The rotary wing drone 100 may have various structures.

In this connection, the body of the rotary wing drone 100 may refer to a collection of components of the rotary wing drone 100.

As shown in FIG. 2, the rotary wing drone 100 includes a top cover 210, a plurality of upper rotor blades 310, 320, a plurality of lower rotor blades 330, 340, fixed casings 221, 222, and 223, rotatable casings 231, 232, a guard 400, a bottom cover 240, and a camera 121.

The rotary wing drone 100 incorporates the casings that form the appearance thereof. The casings may include the top cover 210, the fixed casings 221, 222, and 223, the rotatable casings 231, 232 and the bottom cover 240. These casings 210, 221, 222, 223, 231, 232, and 240 may be formed by injection molding of a synthetic resin, or may be made of metal such as stainless steel (STS), aluminum (Al), titanium (Ti), or the like.

In one example, the rotary wing drone may have a water-proof portion (not shown) that prevents water from penetrating into the body. Each water-proof portion may be disposed and seal between the top cover 210 and the first fixed casing 221, between the bottom cover 240 and the third fixed casing 223, between the first rotatable casing 231 and the first fixed casing 221, between the second fixed casing 222 and the first rotatable casing 231, between the second fixed casing 222 and the second rotatable casing 231, between the second rotatable casing 231 and the third fixed casing 223.

The fixed casings 221, 222, and 223 may be fixed to the main body and not rotate to be non-associated with the rotation of the rotor blades 310, 320, 330, and 340.

The rotating casings 231 and 232 rotate together with the rotor blades 310, 320, 330, and 340 in the rotational direction of the rotor blades 310, 320, 330, and 340 when the rotor blades 310, 320, 330, 330, and 340 rotate.

In order to reduce the frictional force generated when the rotatable casings 231 and 232 rotate, lubricant may be applied to contact surfaces between the rotatable casings 231 and 232 and the fixed casings 221, 222, and 223. Further, at least one of a bushing and bearing may be provided between the rotatable casings 231 and 232 and the fixed casings 221, 222, and 223.

The top cover 210 has a detachable structure from the first fixed casing 221.

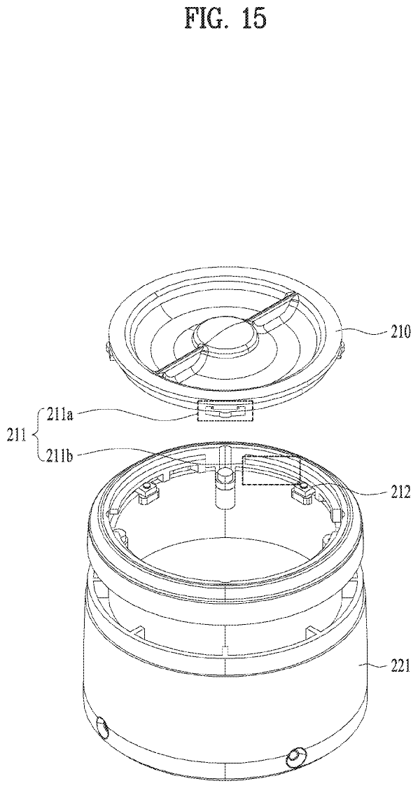

The top cover 210 may perform a switch function while the cover 210 is coupled to the first fixed casing 221. This will be described more detail later in FIG. 15.

The first fixed casing 221 may be positioned between the top cover 210 and the first rotatable casing 231.

When the rotor blades 310, 320, 330, and 340 rotate, the first fixed casing 221 may not rotate while being fixed to the main body.

The first fixed casing 221 may also serve to protect the internal components of the rotary wing drone.

The first fixed casing 221 may include an optical output unit. The optical output unit may emit light in a pre-set pattern and pre-set color to inform the user of the event that the rotary wing drone 100 is powered on, or an event that a battery level corresponds to a pre-set level. Preferably, the optical output unit may be disposed between the first fixed casing 221 and the top cover 210.

In one example, according to the prior art, the rotor blade of the rotary wing drone has a lead-lag hinge and a flapping hinge. However, the rotary wing drone according to one embodiment of the present disclosure does not have a lead-lag hinge and a flapping hinge. Therefore, there is an advantage that the structure becomes simpler.

In one example, the plurality of upper rotor blades 310, and 320 may be rotated in a first direction upon receiving a torque from a first motor built into the rotary wing drone. The plurality of lower rotor blades 330, 340 may be rotated in a second direction upon receiving a torque from a second motor built into the rotary wing drone.

The first direction and the second direction may be opposite to each other. For example, when the first direction is clockwise, the second direction may be counterclockwise.

The first rotatable casing 231 may rotate in the first direction, such as the plurality of upper rotor blades 310, and 320.

The second rotatable casing 232 may rotate in the second direction together with the plurality of lower rotor blades 330, 340, and 340.

Thus, the first rotatable casing 231 and the second rotatable casing 232 may rotate in opposite directions.

The second fixed casing 222 may be positioned between the first rotatable casing 231 and the second rotatable casing 232.

The second fixed casing 221 may serve to protect the internal components of the rotary wing drone. In particular, the second fixed casing 221 may receive the first motor and the second motor therein. Thus, the second fixed casing 221 may serve to protect the first motor and the second motor.

In one example, when the first motor and the second motor built in the rotary wing drone 100 operate, the first motor and the second motor may generate heat. Thus, when the internal air of the rotary wing drone 100 is not circulated to the outside, the first motor and the second motor have a short life due to the generated heat. Thus, the rotary wing drone 100 may have a vent hole that define an air communication channel between the rotary wing drone 100 and external air.

An inlet 520 of the vent hole may be positioned in the second fixed casing 222. Then, outlet 511s and 512 of the vent hole may be positioned in the first rotatable casing 231 and the second rotatable casing 232, respectively. Then, each of the first rotatable casing 231, the second rotatable casing 232 and the second fixed casing 222 may have an internal structure in which air may flow freely therein.

Through the inlet 520 of the vent hole, external cool air can be introduced into the second fixed casing 222 to cool the first and second motors. Then, air heated inside the second fixed casing 222 may be vented using the vent hole outlets 511 and 512.

Specifically, the first rotatable casing 231 and the second rotatable casing 232 may have radial fins installed therein. Thus, when the first rotatable casing 231 and the second rotatable casing 232 rotate, the air may be discharged through the first vent hole outlet 511 and the second vent hole outlet 512 to the outside. The air in the second fixed casing 222 flows into the first rotatable casing 231 and the second rotatable casing 232 as the air in the first rotatable casing 231 and the second rotatable casing 232 is discharged to the outside. As the air in the second fixed casing 222 exits, external air enters the second fixed casing 222 through the vent hole inlet 520. Then, as cold external air enters the second fixed casing 222, the first motor 710 and the second motor 720 inside the second fixed casing 222 may be cooled.

In one example, the guard 400 may protect the rotor blades 310, 320, 330, and 340 when the rotor blades 310, 320, 330, and 340 rotate.

The guard 400 may be removable from the first fixed casing 221 and the third fixed casing 223. In one example, according to an embodiment, the rotor blades 310, 320, 330, and 340 may be folded in a down direction or upward direction. Thus, the user collapses the rotor blades 310, 320, 330, and 340. Then, the guard 400 may be detached from the rotary wing drone 100 to minimize the volume of the rotary wing drone 100.

In one example, the bottom cover 240 may have a removable structure from the third fixed casing 223. Alternatively, the bottom cover 240 may be coupled to the third fixed casing 223 to be non-removable therefrom.

In one example, the camera 121 may be coupled to the bottom cover 240.

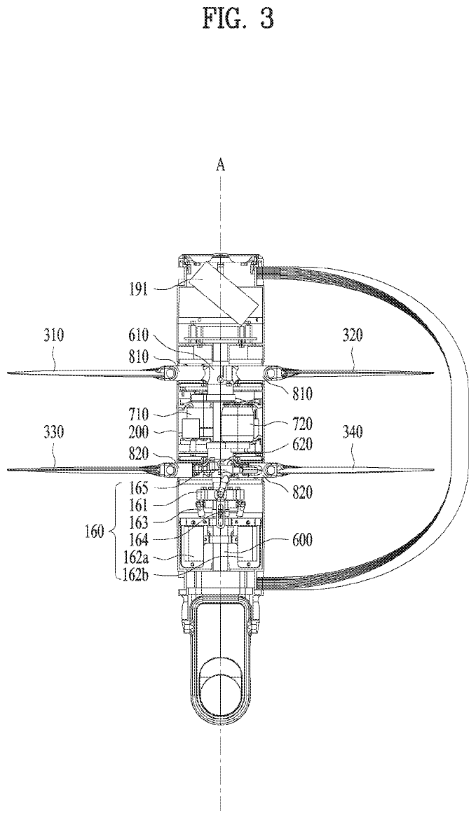

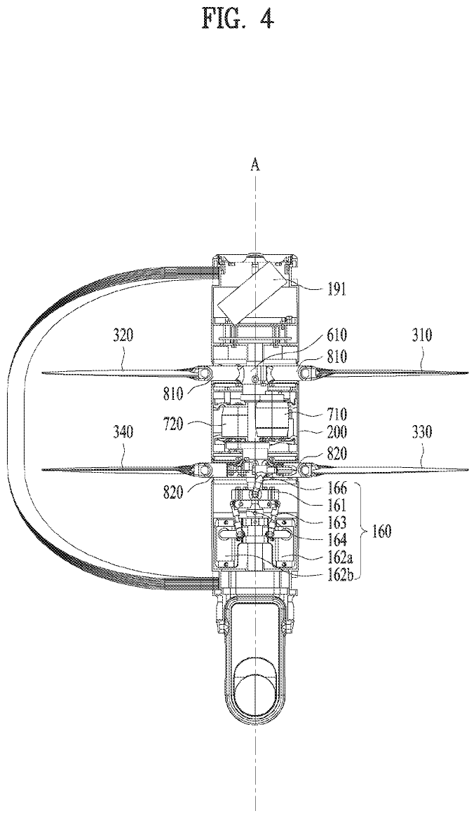

FIG. 3 shows the internal structure of the front face of the rotary wing drone. FIG. 4 shows the internal structure of the back face of the rotary wing drone.

At least one of the power supply 190, the flight controller 181, a central shaft 600, an upper shaft 610, a lower shaft 620, the first motor 710, the second motor 720, the first hub 810, the second hub 820, and the pitch control mechanism 160 may be provided in the main body 200 of the rotary wing drone 100. The components shown in FIG. 3 and FIG. 4 may not be essential to implement the rotary wing drone 100. Thus, the rotary wing drone 100 as described herein may have components that are more or less than the components listed above.

The main body 200 may refer to an assembly incorporating the casings defining the appearance of the rotary wing drone 100, the central shaft 600, and a framework 250 inside the rotary wing drone 100.

The casings may include the top cover 210, fixed casings 221, 222, and 223, rotatable casings 231, 232, and bottom cover 240.

The central shaft 600 is inserted vertically into the main body 200 and may have a non-rotating structure. That is, the central shaft 600 does not rotate when the rotor blades 310, 320, 330, and 340 rotate.

The components that do not rotate in the rotary wing drone 100 may be coupled to the central shaft 600 in a non-rotating manner. The components that rotate inside the rotary wing drone 100 may be coupled to the central shaft 600 in a rotatable manner.

The components that do not rotate in the rotary wing drone 100 may include at least the top cover 210, the fixed casings 221, 222, and 223, the bottom cover 240, the guard 400, the first motor 710, the second motor 720, a stationary portion 161b of the swash plate 161, tilt adjusters 162a and 162b, a third linkage 163, a fourth linkage 164, the camera 121, the framework 250 and the battery 191. However, the present disclosure is not limited thereto.

The rotatable components in the rotary wing drone 100 may include at least the rotatable casings 231 and 232, rotor blades 310 and 320, 330 and 340, first linkage 165, second linkage 166, upper shaft 610, lower shaft 620, upper hub 810 and lower hub 820. However, the present disclosure is not limited thereto.

The framework 250 supports the components built into the rotary wing drone 100.

The power supply 190 may include the battery 191. The battery 191 may be positioned at the top of a rotary wing drone 100.

According to one embodiment, the battery 191 may be in the form of a rectangle. In this case, the battery 191 may be inserted obliquely inside the casing of the rotary wing drone 100.

According to another embodiment, the battery 191 may be in a form of a cylinder. When the battery 191 is in the form of the cylinder, the casing of the rotary wing drone 100 may be cylindrical in a shape. This minimizes an empty space inside the rotary wing drone 100. Further, when inserting the battery 191 at an inclined manner into the casing, a larger capacity battery may be inserted into the casing.

The battery 191 may power the motors 710 and 720 and tilt adjusters 162a and 162b, which are built into the rotary wing drone 100.

The first motor 710 and the second motor 720 may be disposed below the upper shaft 610. Then, the first motor 710 and the second motor 720 may be located above the lower shaft 620. That is, the first motor 710 and the second motor 720 may be positioned between the upper shaft 610 and the lower shaft 620.

In one example, each of the first motor 710 and the second motor 720 may be embodied as a brush DC motor or may be embodied as a brushless DC motor having a hollow shaft. For the sake of convenience of illustration, it may be assumed that each of the first motor 710 and the second motor 720 is embodied as the brush DC motor in FIG. 3 and FIG. 4.

The upper shaft 610 and the lower shaft 620 may be rotatably coupled to the central shaft 600. Each of the upper shaft 610 and the lower shaft 620 may be lubricated on a side face thereof contacting the central shaft 600. At least one of a bushing and a bearing may be provided between the upper shaft 610 and the central shaft 600. At least one of a bushing and a bearing may be provided between the lower shaft 620 and the central shaft 600.

The upper shaft 610 may be inserted vertically into the main body 200, and may be powered by the first motor 710 and thus may rotate in the first direction around a first axis A.

The lower shaft 620 may be inserted vertically into the main body 200, and may be powered by the second motor 720 and thus rotate in the second direction around the first axis A.

The first direction may be the opposite direction to the second direction. For example, the first direction may be a clockwise direction, while the second direction may be a counterclockwise direction. However, the present invention is not limited thereto.

That is, the upper shaft 610 and the lower shaft 620 rotate in opposite directions about the same first axis A.

In one example, the plurality of upper rotor blades (e.g., the first rotor blade 310 and the second rotor blade 320) may be coupled to the upper shaft 610 to rotate in the first direction about the first axis A. In this case, each of the first rotor blade 310 and the second rotor blade 320 may have a structure in which a pitch angle thereof does not change when rotating in the first direction.

Specifically, each of the first rotor blade 310 and the second rotor blade 320 may be coupled to the upper hub 810 such that the pitch angle thereof is fixed. That is, the first rotor blade 310 and the second rotor blade 320 are fixedly coupled to a single upper hub 810. Then, the upper hub 810 may be coupled to the upper shaft 610.

The plurality of lower rotor blades (e.g., the third rotor blade 330 and the fourth rotor blade 340) may be coupled to the lower shaft 620 to rotate in the second direction about the first axis A. In this case, each of the third rotor blade 330 and the fourth rotor blade 340 may be coupled to the lower hub 820 so that a pitch angle thereof may vary. Then, the lower hub 820 may be coupled to the lower shaft 620.

Therefore, when the lower hub 820 receives a rotating force from the second motor and rotates in the second direction, the lower hub 820 may rotate together with the lower shaft 620.

In one example, the pitch control mechanism 160 may include a swash plate 161, a first tilt adjuster 162a, a second tilt adjuster 162b, a first linkage 165, a second linkage 166, a third linkage 163, and a fourth linkage 164.

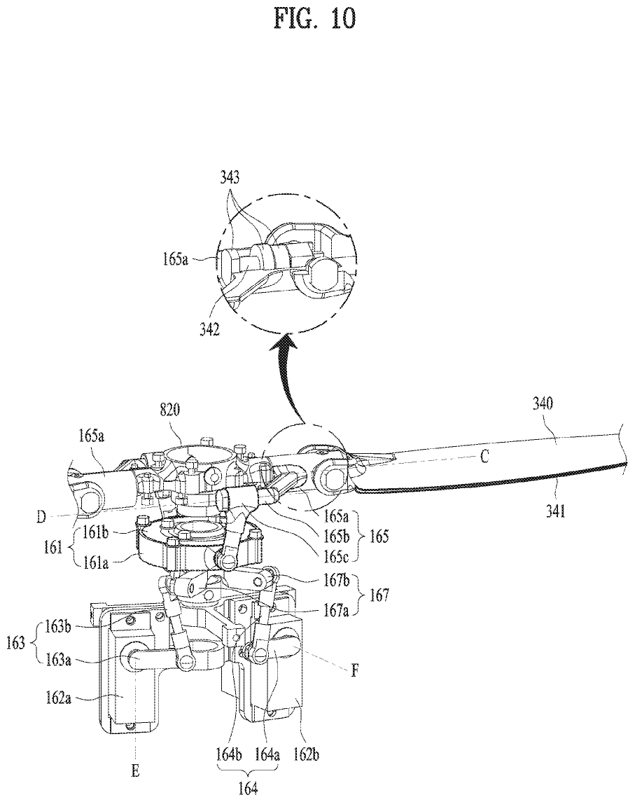

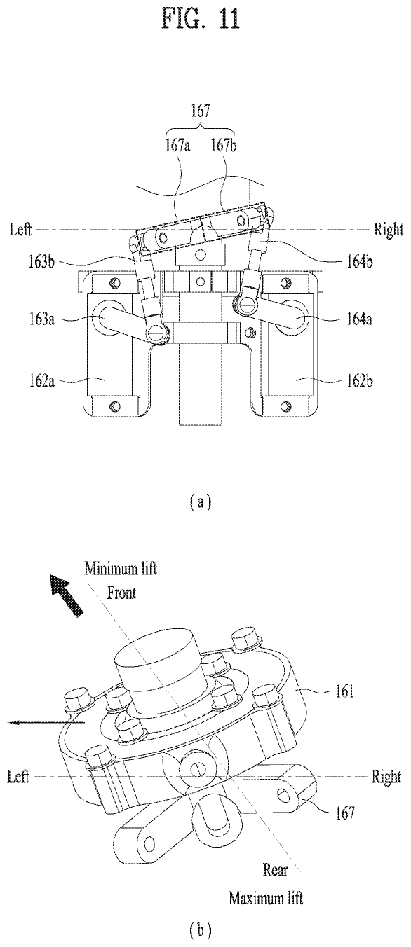

When the third rotor blade 330 and the fourth rotor blade 340 rotate, the pitch control mechanism 160 serves to vary the pitch angle of each of the third rotor blade 330 and the fourth rotor blade. How the pitch control mechanism 160 adjusts the pitch angle of each of the third rotor blade 330 and the fourth rotor blade 340 will be described in more detail in FIG. 10 to FIG. 14.

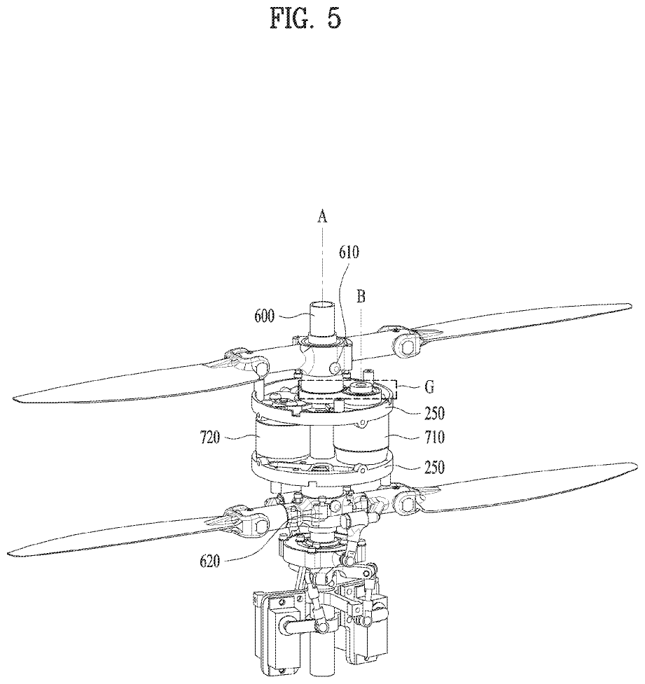

FIG. 5 is an illustration of one example of how the motor delivers torque to the upper and lower shafts in the rotary wing drone according to one embodiment of the present disclosure. FIG. 5 assumes that the first and second motors are brush DC motors.

The upper shaft 610 is rotatably coupled to the central shaft 600 of a non-rotatable structure. The upper shaft 610 may rotate about the first axis A.

The framework 250 may be installed on the central shaft 600 of the non-rotatable structure such that the framework 250 does not rotate. The first motor 710 and the second motor 720 may be fixed to the framework 250.

The first motor 710 and the second motor 720 may be disposed in the space between the upper shaft 610 and the lower shaft 620. For the coaxial inverted rotor, because a plurality of upper rotor blades and a plurality of lower rotor blades are required to maintain a pre-set spacing therefrom, placing the first motor 710 and the second motor 720 in the space between the plurality of upper rotor blades and the plurality of lower rotor blades may allow the volume of the rotary wing drone to be minimized.

In one example, the first motor 710 and the upper shaft 610 may have different rotation axes. In this case, the torque generated from the first motor 710 may be transmitted to the upper shaft 610 via a gear G.

Specifically, when the rotation axis of the first motor 710 is the second axis B other than the first axis A, the rotational force generated from the first motor 710 may be transmitted to the upper shaft 610 via the gear G.

A manner in which the second motor 720 transmits a rotating force to the lower shaft 620 may be the same as a manner in which the first motor 710 delivers a rotating force to the upper shaft 610. Thus, an overlapping detailed description therebetween will be omitted.

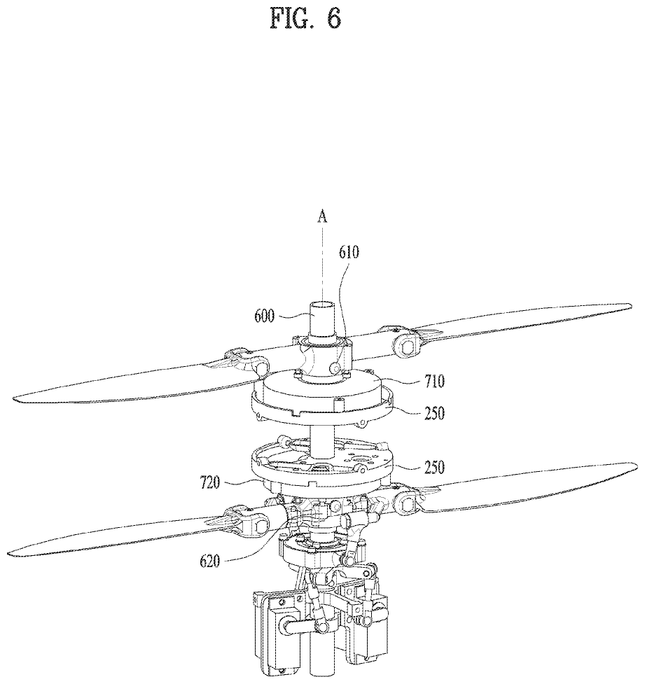

FIG. 6 is an illustration of another example of how a motor transmits a rotating force to an upper shaft and a lower shaft in a rotary wing drone according to one embodiment of the present disclosure. In FIG. 6, it is assumed that each of the first motor and the second motor is embodied as a brushless DC motor with a hollow shaft.

The upper shaft 610 is rotatably coupled to the central shaft 600 of a non-rotatable structure. The upper shaft 610 may rotate about the first axis A.

The framework 250 may be installed on the central shaft 600 of the non-rotatable structure so as not to rotate. The first motor 710 and the second motor 720 may be fixed to the framework 250.

The first motor 710 and the second motor 720 may be disposed in the space between the upper shaft 610 and the lower shaft 620. For the coaxial inverted rotor, because a plurality of upper rotor blades and a plurality of lower rotor blades are required to maintain a pre-set spacing therefrom, placing the first motor 710 and the second motor 720 in the space between the plurality of upper rotor blades and the plurality of lower rotor blades may allow the volume of the rotary wing drone to be minimized.

When each of the first motor 710 and the second motor 720 is embodied as the brushless DC motor with a hollow shaft, the central shaft 600 may pass through the first motor 710 and the second motor 720. That is, a central portion of each of the first motor 710 and the second motor 720 may have a hollow cylindrical space, so that the central shaft 600 may pass through the hollow space.

In one example, the rotation axis of the first motor 710 may define the first axis A, which is the rotation axis of the upper shaft 610. Then, the upper shaft 610 may be connected directly to the first motor.

That is, rather than a configuration that the rotating force of the first motor 710 is transmitted to the upper shaft 610 via the gear G as shown in FIG. 5, the rotating force generated by the first motor 710 may be transmitted directly to the upper shaft 610. That is, the first motor 710 may rotate the upper shaft 610 directly.

The manner in which the second motor 720 transmits a rotating force to the lower shaft 620 is the same as the manner in which the first motor 710 transmits a rotating force to the upper shaft 610. Thus, an overlapping detailed description therebetween will be omitted.

When the upper shaft 610 and the lower shaft 620 are rotated upon receiving the rotating force directly from the first motor 710 and the second motor 720, friction may be reduced and efficiency may increase compared to a case when the first motor 710 and the second motor 720 transmit a rotating force to the upper shaft 610 and the lower shaft 620 via the gear G. Further, in the former case, thrust loss may be reduced, and noise may be reduced, the total volume of the rotary wing drone may be reduced, and the vibration generated in the rotary wing drone 100 may be reduced.

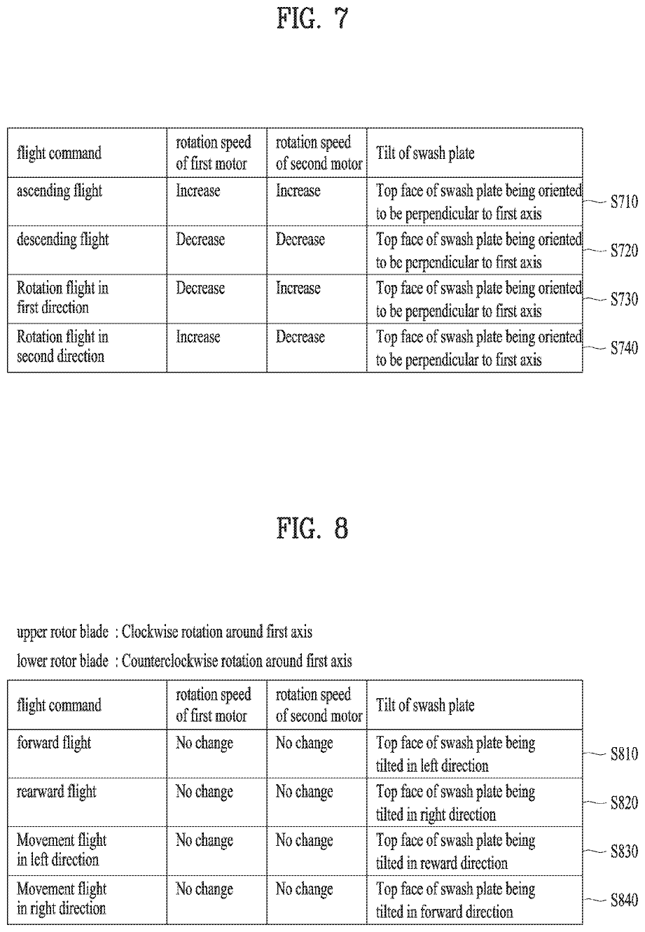

FIG. 7 is a table describing one example of how to control a first motor and second motor and adjust a tilt of a swash plate according to a flight command in a rotary wing drone according to one embodiment of the present disclosure.

Lengths of the plurality of upper rotor blades 310 and 320 and the plurality of lower rotor blades 330 and 340 may be assumed to be the same with respect to FIG. 7.

The first motor 710 may be rotating at the first rotation speed. Then, the second motor 720 may be rotating at the first rotation speed. In this case, the plurality of upper rotor blades 310 and 320 may receive a rotating force from the first motor 710 and rotate in the first direction about the first axis A. Further, the plurality of lower rotor blades 330 and 340 receive a rotating force from the second motor 720 and rotate about the first axis in the second direction opposite to the first direction.

Because the plurality of lower rotor blades 330 and 340 rotate in a direction opposite to the rotation direction of the plurality of upper rotor blades 310 and 320, the reaction torque as generated when the plurality of upper rotor blades 310 and 320 rotate may be canceled by the reaction torque as generated when the plurality of lower rotor blades 330 and 340 rotate.

In one example, when an ascending flight command is detected S710, the flight controller 181 may control the first motor 710 and the second motor 720 to increase the rotation speeds of the first motor 710 and the second motor 720 to be higher than a first rotation speed. In this case, the rotation speeds of the upper rotor blades 310 and 320 and the plurality of lower rotor blades 330 and 340 are increased, and thus the lift applied to the rotary wing drone 100 is increased. Thus, the rotary wing drone 100 will make the ascending flight.

In this connection, when the rotary wing drone 100 does not move forward, rearward or sideward, the swash plate 161 should not have a tilt. Specifically, when an ascending flight command is detected S710, the flight controller 181 may control the tilt adjusters 162a and 162b such that the top face of the swash plate 161 is perpendicular to the first axis A so that the pitch angle of the plurality of lower rotor blades 330 and 340 rotating in the second direction does not change.

In one example, when a descending flight command is detected S720, the flight controller 181 may control the first motor 710 and the second motor 720 to decrease the rotation speed of each of the first motor 710 and the second motor 720 to be lower than the first rotation speed. In this case, the rotation speeds of the upper rotor blades 310 and 320 and the plurality of lower rotor blades 330 and 340 are reduced, such that the lift applied to the rotary wing drone 100 is reduced. Thus, the rotary wing drone 100 may perform a descending flight.

However, in this case, when the rotary wing drone 100 does not move forward, rearward or sideward, the swash plate 161 should not have a tilt. Specifically, when the descending flight command is detected S720, the flight controller 181 may control the tilt adjusters 162a and 162b such that the top face of the swash plate 161 is perpendicular to the first axis A so that the pitch angle of the plurality of lower rotor blades 330 and 340 rotating in the second direction does not change.

When the flight controller 181 detects a flight command to rotate in the first direction S730, the flight controller 181 may reduce the rotation speed of the first motor 710 to be lower than the first rotation speed, thereby to reduce the rotation speed of the plurality of upper rotor blades 310 and 320 rotating in the first direction. Further, when the flight controller 181 detects a flight command to rotate in the first direction S730, the flight controller 181 may increase the rotation speed of the second motor 730 to be higher than the first rotation speed, thereby to increase the rotation speed of the plurality of lower rotor blades 330, and 340 rotating in the second direction. In this case, the reaction torque generated by the plurality of upper rotor blades 310 and 320 is canceled, while the reaction torque generated by the plurality of lower rotor blades 330, and 340 increases. Thus, the rotary wing drone 100 rotates in the first direction opposite to the second direction, which is the rotational direction of the lower rotor blades 330 and 340.

In this connection, when the rotary wing drone 100 does not move forward, rearward or sideward, the swash plate 161 should not have a tilt. Specifically, when an ascending flight command is detected S710, the flight controller 181 may control the tilt adjusters 162a and 162b such that the top face of the swash plate 161 is perpendicular to the first axis A so that the pitch angle of the plurality of lower rotor blades 330 and 340 rotating in the second direction does not change.

When the flight controller 181 detects a flight command to rotate in the second direction S740, the flight controller 181 may reduce the rotation speed of the first motor 710 to be higher than the first rotation speed, thereby to increase the rotation speed of the plurality of upper rotor blades 310 and 320 rotating in the first direction. Further, when the flight controller 181 detects a flight command to rotate in the second direction S730, the flight controller 181 may decrease the rotation speed of the second motor 730 to be lower than the first rotation speed, thereby to decrease the rotation speed of the plurality of lower rotor blades 330, and 340 rotating in the second direction. In this case, the reaction torque generated by the plurality of upper rotor blades 310 and 320 is canceled, while the reaction torque generated by the plurality of lower rotor blades 330, and 340 increases. Thus, the rotary wing drone 100 flies with rotating in the second direction opposite to the first direction, which is the rotational direction of the upper rotor blades 310 and 320.

In this connection, when the rotary wing drone 100 does not move forward, rearward or sideward, the swash plate 161 should not have a tilt. Specifically, when an ascending flight command is detected S710, the flight controller 181 may control the tilt adjusters 162a and 162b such that the top face of the swash plate 161 is perpendicular to the first axis A so that the pitch angle of the plurality of lower rotor blades 330 and 340 rotating in the second direction does not change.

Conventionally, when the controller detects an ascending flight command, a descending flight command, or a rotating flight command in the rotary wing drone, the controller may perform the collective pitch control of the upper rotor blades 310, and 320 and the lower rotor blades 330 and 340. However, in accordance with the present disclosure, only the control of the rotation speeds of the first motor 710 and the second motor 720 may allow the drone to perform an ascending flight, a descending flight, or a revolving flight. Therefore, in accordance with the present disclosure, the effect of the flight control may become simpler.

FIG. 8 is a table describing another example of how to control a first motor and second motor and adjust a tilt of a swash plate according to a flight command in a rotary wing drone according to one embodiment of the present disclosure. Referring to FIG. 8, it may be assumed that the plurality of upper rotor blades 310, and 320 are rotating in a clockwise direction about the first axis A, while the plurality of lower rotor blades 330, and 340 rotate counterclockwise about the first axis A.

According to one embodiment of the present disclosure, when a horizontal movement flight command is detected, the flight controller 181 may control the first motor 710 and the second motor 720 to maintain the rotation speed thereof (S810, S820, S830 and S840). In this connection, the horizontal movement flight means that the rotary wing drone 100 performs a forward, rearward or sideward flight while maintaining the altitude thereof.

However, when the horizontal movement flight command is detected, the flight controller 181 may control the tilt adjusters 162a and 162b to tilt the swash plate so that the top face of the swash plate 161 is tilted to the left with respect to a direction corresponding to the flight command.

In one example, when a forward flight command is detected, the flight controller 181 may control the tilt adjusters 162a and 162b such that the top face of the swash plate is tilted in the left direction.

In another example, when a rearward flight command is detected, the flight controller 181 may control the tilt adjusters 162a and 162b such that the top face of the swash plate is tilted in the right direction.

In another example, when a left movement flight command is detected, the flight controller 181 may control the tilt adjusters 162a and 162b such that the top face of the swash plate is tilted in the rearward direction.

In another example, when a right movement flight command is detected, the flight controller 181 may control the tilt adjusters 162a and 162b such that the top face of the swash plate is tilted in the forward direction.

According to the prior art, in the rotary wing drone, when the controller detects a forward flight, rearward flight, or sideward flight command, the controller may perform a cyclic pitch control of the plurality of upper rotor blades 310 and 320 and a plurality of lower rotor blades 330, and 340. However, in accordance with the present disclosure, the controller may perform the cyclic pitch control only of the plurality of lower rotor blades 330, and 340. Therefore, in accordance with the present disclosure, the advantage that the rotary wing drone 100 has a simpler structure may be achieved.

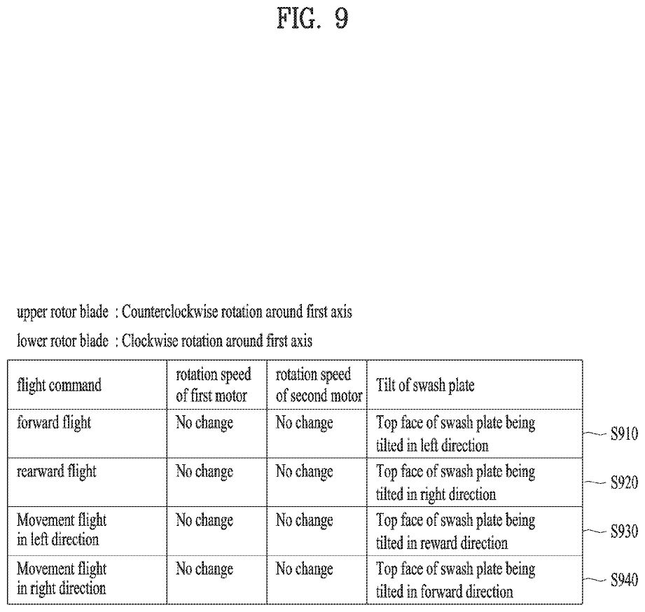

FIG. 9 is a table describing still another example of how to control a first motor and second motor and adjust a tilt of a swash plate according to a flight command in a rotary wing drone according to one embodiment of the present disclosure. Referring to FIG. 9, it may be assumed that the plurality of upper rotor blades 310, and 320 are rotating in a counterclockwise direction about the first axis A, while the plurality of lower rotor blades 330, and 340 rotate clockwise about the first axis A.

According to one embodiment of the present disclosure, when a horizontal movement flight command is detected, the flight controller 181 may control the first motor 710 and the second motor 720 to maintain the rotation speeds thereof (S810, S820, S830 and S840). In this connection, the horizontal movement flight means that the rotary wing drone 100 performs a forward, rearward or sideward flight while maintaining the altitude thereof.

However, when the horizontal movement flight command is detected, the flight controller 181 may control the tilt adjusters 162a and 162b to tilt the swash plate so that the top face of the swash plate 161 is tilted to the right with respect to a direction corresponding to the flight command.

In one example, when a forward flight command is detected, the flight controller 181 may control the tilt adjusters 162a and 162b such that the top face of the swash plate is tilted in the right direction.

In another example, when a rearward flight command is detected, the flight controller 181 may control the tilt adjusters 162a and 162b such that the top face of the swash plate is tilted in the left direction.

In another example, when a left movement flight command is detected, the flight controller 181 may control the tilt adjusters 162a and 162b such that the top face of the swash plate is tilted in the forward direction.

In another example, when a right movement flight command is detected, the flight controller 181 may control the tilt adjusters 162a and 162b such that the top face of the swash plate is tilted in the rearward direction.

According to the prior art, in the rotary wing drone, when the controller detects a forward flight, rearward flight, or sideward flight command, the controller may perform a cyclic pitch control of the plurality of upper rotor blades 310 and 320 and a plurality of lower rotor blades 330, and 340. However, in accordance with the present disclosure, the controller may perform the cyclic pitch control only of the plurality of lower rotor blades 330, and 340. Therefore, in accordance with the present disclosure, the advantage that the rotary wing drone 100 has a simpler structure may be achieved.

FIG. 10 is an illustration of one example of how to adjust a pitch angle of the plurality of lower rotor blades using a pitch control mechanism in a rotary wing drone according to an embodiment of the present disclosure.

FIG. 10 is a rear view of some of the components built into the rotary wing drone.

The pitch control mechanism 160 may include a swash plate 161, a first tilt adjuster 162a, a second tilt adjuster 162b, a first linkage 165, a second linkage 166, a third linkage 163, a fourth linkage 164 and a support 167.

Referring to FIG. 10, the plurality of lower rotor blades 330 and 340 may be coupled to the lower hub 820. In this connection, when the plurality of lower rotor blades 330 and 340 rotate, the pitch angle thereof changes. Thus, the plurality of lower rotor blades 330 and 340 may be coupled to the lower hub 820 via the first linkage 165. Hereinafter, for convenience of description, only the fourth rotor blade 340 is described. However, the following description may be applied to the third rotor blade 330 as well.

The first linkage 165 may include a first link 165a, an arm 165b, and a second link 165c.

One end of the first link 165a may be fixedly coupled to one end of the fourth rotor blade 340.

The other end of the first link 165a may be rotatably coupled to the lower shaft 620.

Specifically, the first link 165a may be a hollow structure. Then, a rotatable column 342 may be embedded within the first link 165a. The rotatable column 342 may be rotatably coupled to the lower hub 820. In one example, a plurality of bearings 343 may be coupled to the rotatable column 342. The plurality of bearings 343 may include bearings to withstand a axial load and bearings to withstand a moment. Thus, the first link 165a may be coupled to the lower shaft 620 to be rotatable about a third axis C.

In one example, one end of the arm 165b may be joined to one end of the first link 165a.

One end of the second link 165c may be rotatably coupled to the other end of the arm 165b. The arm 165b may be coupled to the second link 165c to be rotatable about a fourth axis D.

The other end of the second link 165c may be coupled to the swash plate 161.

Specifically, the swash plate 161 includes a rotatable portion 161a and a stationary portion 161b. The stationary portion 161b is coupled to the central shaft 600 so as not to rotate. In one example, the rotatable portion 161a is rotatably coupled to the stationary portion 161b and extends along the outer circumferential surface of the stationary portion 161b. The second link 165c may be coupled to the rotatable portion 161a of the swash plate 161.

When the fourth rotor blade 340 rotates, a rotating force thereof may be transmitted via the first linkage 165 to the rotatable portion 161a of the swash plate 161 to rotate the rotatable portion 161a together with the fourth rotor blade 340.

When the swash plate 161 is oriented to be perpendicular to the extension direction of the central shaft, the first linkage 165 rotates together with the fourth rotor blade 340 but does not move up and down.

However, when the top face of the swash plate 161 is tilted in a specific direction, the first linkage 165 may be moved up and down while rotating with the rotatable portion 161a of the swash plate 161.

For example, assuming that the top face of the swash plate 161 is tilted in the forward direction, the rear portion of the swash plate 161 is raised up. When the first linkage 165 passes past the rear portion of the swash plate 161 while the first linkage 165 is rotating, the second link 165c moves in an upward direction and then descends in a downward direction. When the second link 165c moves up in the upward direction, the second link 165c will raise the arm 165b in an upward direction. When the arm 165b is raised in an upward direction, the first link 165a rotates around the third axis C. Then, as the first link 165a rotates, the blade 341 of the fourth rotor blade 340 moves in an upward direction. In one example, when the second link 165c goes downward, the second link 165c descends the arm 165b in a downward direction. When the arm 165b goes downward, the first link 165a rotates around the third axis C. Then, as the first link 165a rotates, the blade 341 of the fourth rotor blade 340 move in a downward direction. Accordingly, the pitch of the fourth rotor blade 340 changes while the fourth rotor blade 340 is rotating.

In one example, the tilt of the swash plate 161 may be controlled using the tilt adjusters 162a and 162b. More specifically, the tilt adjusters 162a and 162b may apply a force to the support 167 to adjust the tilt of the swash plate 161. In this connection, the support 167 may be coupled to the stationary portion 161b of the swash plate 161.

First, the first support 167a as a left portion of the support 167 may be connected to the first tilt adjuster 162a at the left side of the first support 167a via the third linkage 163. The third linkage 163 may include a third link 163a and a fourth link 163b.

Specifically, one end of the third link 163a is rotatably coupled to the first tilt adjuster 162a. The third link 163a may be rotated clockwise or anticlockwise about the fifth axis upon receiving the rotation force from the first tilt adjuster 162a. One end of the fourth link 163b may be rotatably coupled to the other end of the third link 163a. The other end of the fourth link 163b may be rotatably coupled with one end of the first support 167a. Then, the other end of the first support 167a may be coupled to the stationary portion 161b.

In one example, the second support 167b as a right portion of the support 167 may be connected to the second tilt adjuster 162b at the right side of the second support 167b via the fourth linkage 164. The fourth linkage 164 may be composed of a fifth link 164a and a sixth link 164b.

Specifically, one end of the fifth link 164a is rotatably coupled to the second tilt adjuster 162b. The fifth link 164a may be rotated clockwise or counterclockwise about the fifth axis E up receiving force from the second tilt adjuster 162b. One end of the sixth link 164b may be rotatably coupled to the other end of the fifth link 164a. The other end of the sixth link 164b may be rotatably coupled to the one end of the second support 167b. Then, the other end of the second support 167b may be coupled to the stationary portion 161b.

Hereinafter, referring to FIGS. 11 to 14, a description will be given of a method in which the flight controller 181 controls the tilt adjusters 162a and 162b to adjust the tilt of the swash plate for the drone to perform the forward, rearward, or sideward flight. With reference to FIG. 11 to FIG. 14, it may be assumed that the plurality of lower rotor blades 330 and 340 are rotating in a counterclockwise direction.

FIG. 11 through FIG. 14 illustrate one example of how to control the tilt adjusters and thus adjust the tilt of the swash plate based on the forward, rearward, or sideward flight command in the rotary wing drone according to one embodiment of the present disclosure.

According to one embodiment of the present disclosure, when a horizontal movement flight command is detected, the flight controller 181 may control the tilt adjusters 162a and 162b so that the swash plate 161 has a tilt.

In one example, referring to FIG. 11a, the flight controller 1810 may control the first tilt adjuster 162a to pivot the third link 163a in a downward or clockwise direction, according to a forward flight command.

When the third link 163a pivots in the downward direction or clockwise direction, the fourth link 163b coupled to one end of the third link 163a may pull the first support 167a in a downward direction.

In one example, the flight controller 1810 may control the second tilt adjuster 162b such that the fifth link 164a pivots in an upward or clockwise direction, according to the forward flight command.

When the fifth link 164a pivots in the upward direction or clockwise direction, the sixth link 164b coupled to one end of the fifth link 164a may push the second support 167b in an upward direction.

Thus, according to the forward flight command, the top face of the support 167 may be tilted in the left direction.

Referring to FIG. 11b, since the top face of the support 167 is tilted in the left direction, the top face of the swash plate is tilted in the left direction. This is because the support 167 is coupled to the back of the swash plate

When one of the plurality of lower rotor blades 330 and 340 is positioned at a front position while is rotating, the pitch angle is minimized due to the effect of the first linkage 165 or second linkage 166. Thus, a lift at the front of the drone is minimized.

Conversely, when one of the plurality of lower rotor blades 330 and 340 is positioned at a rear position while is rotating, the pitch angle is maximized due to the effect of the first linkage 165 or second linkage 166. Thus, a lift at a rear of the drone is maximized.

In this connection, the lift at the front of the rotary wing drone 100 is minimized while a lift at the rear of the drone is maximized, such that the rotary wing drone 100 may perform the forward flight.

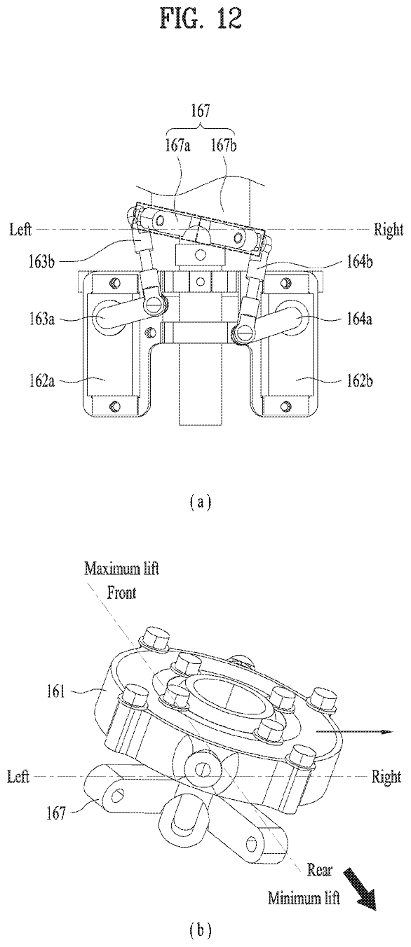

In another example, referring to FIG. 12a, the flight controller 1810 may control the first tilt adjuster 162a to pivot the third link 163a in an upward or counterclockwise direction, according to a rearward flight command. When the third link 163a pivots in the upward direction or anticlockwise direction, the four link 163b coupled to one end of the third link 163a may push the first support 167a in an upward direction.

The flight controller 1810 may control the second tilt adjuster 162b to pivot the fifth link 164a in a downward or counterclockwise direction according to a rearward flight command. When the fifth link 164a pivots in the downward or counterclockwise direction, the sixth link 164b coupled to one end of the fifth link 164a may pull the second support 167b in a downward direction.

Thus, according to the rearward flight command, the top face of the support 167 may be tilted in the right direction.

Referring to FIG. 12b, since the top face of the support 167 is tilted to the right direction, the top face of the swash plate is tilted in the right direction. This is because the support 167 is coupled to the back of the swash plate.

When one of the plurality of lower rotor blades 330 and 340 is positioned at a front position while is rotating, the pitch angle is maximized due to the effect of the first linkage 165 or second linkage 166. Thus, a lift at the front of the drone is maximized.

Conversely, when one of the plurality of lower rotor blades 330 and 340 is positioned at a rear position while is rotating, the pitch angle is minimized due to the effect of the first linkage 165 or second linkage 166. Thus, a lift at a rear of the drone is minimized.

In this connection, the lift at the front of the rotary wing drone 100 is maximized while a lift at the rear of the drone is minimized, such that the rotary wing drone 100 may perform the reward flight.

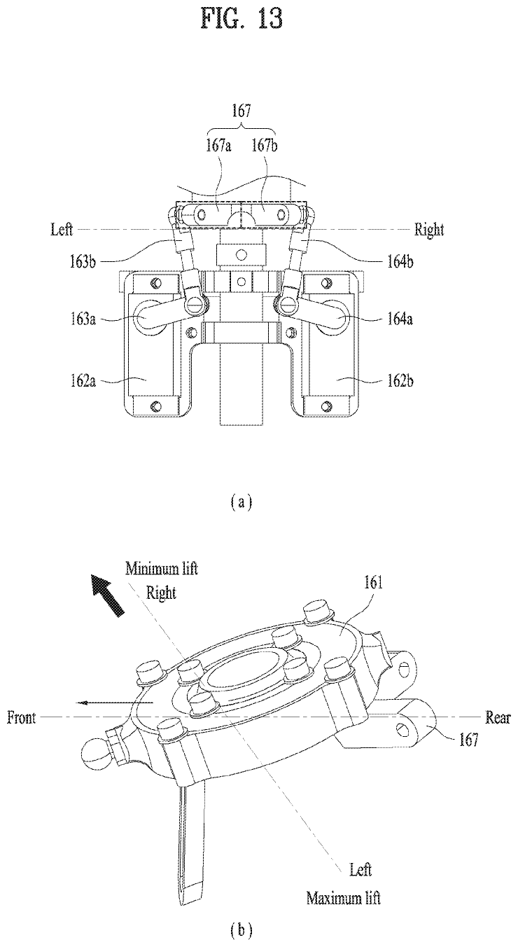

In still another example, Referring to FIG. 13a, the flight controller 1810 may control the first tilt adjuster 162a to pivot the third link 163a in an upward or counterclockwise direction, according to the right movement flight command.

When the third link 163a pivots in an upward direction or counterclockwise direction, the fourth link 163b coupled to one end of the third link 163a may push the first support 167a in an upward direction.

The flight controller 1810 may control the second tilt adjuster 162b to pivot the fifth link 164a in an upward direction or in a clockwise direction, according to the right movement flight command. When the fifth link 164a pivots in the upward direction or clockwise direction, the sixth link 164b coupled to one end of the fifth link 164a may push the second support 167b in an upward direction.

Thus, according to the right movement flight command, the support 167 may be pushed upwards.

Referring to FIG. 13b, as the support 167 has been pushed upwards, the top face of the swash plate tilts in the front direction. This is because the support 167 is coupled to the back of the swash plate.

When one of the plurality of lower rotor blades 330 and 340 is positioned at a left position while is rotating, the pitch angle is maximized due to the effect of the first linkage 165 or second linkage 166. Thus, a lift at the left of the drone is maximized.

Conversely, when one of the plurality of lower rotor blades 330 and 340 is positioned at a right position while is rotating, the pitch angle is minimized due to the effect of the first linkage 165 or second linkage 166. Thus, a lift at a right of the drone is minimized.

In this connection, the lift at the left of the rotary wing drone 100 is maximized while a lift at the right of the drone is minimized, such that the rotary wing drone 100 may perform the rightwards flight.

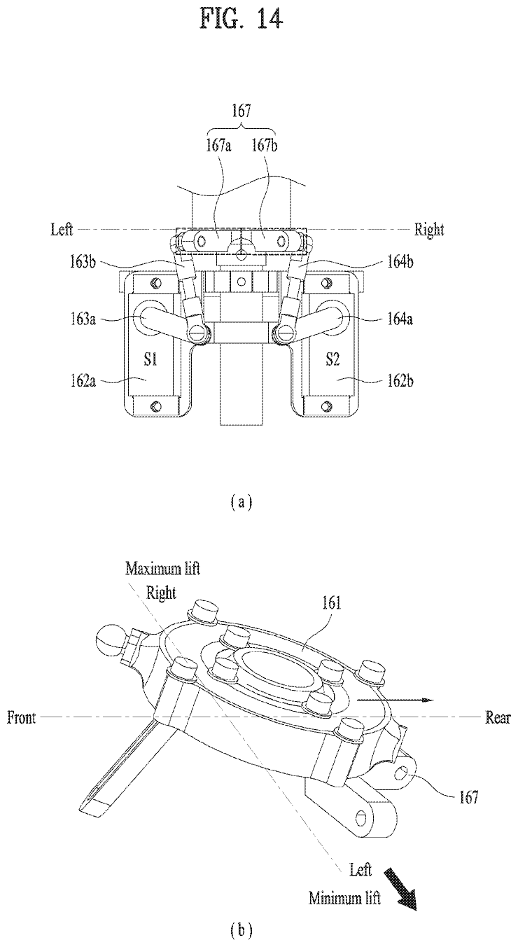

In another example, referring to FIG. 14a, the flight controller 1810 may control the first tilt adjuster 162a to pivot the third link 163a in a downward or clockwise direction, according to the left movement flight command. When the third link 163a pivots in the downward direction, the fourth link 163b coupled to one end of the third link 163a may pull the first support 167a in a downward direction.

The flight controller 1810 may control the second tilt adjuster 162b to pivot the fifth link 164a in a downward or counterclockwise direction, according to the left movement flight command. When the fifth link 164a pivots in the downward direction or counterclockwise direction, the sixth link 164b coupled to one end of the fifth link 164a may pull the second support 167b in a downward direction.

Thus, according to the left movement flight command, the support 167 may be pulled downwards.

Referring to FIG. 14b, as the support 167 has been pulled downward, the top face of the swash plate is tilted in the backward direction. This is because the support 167 is coupled to the back of the swash plate.

When one of the plurality of lower rotor blades 330 and 340 is positioned at a right position while is rotating, the pitch angle is maximized due to the effect of the first linkage 165 or second linkage 166. Thus, a lift at the right of the drone is maximized.

Conversely, when one of the plurality of lower rotor blades 330 and 340 is positioned at a left position while is rotating, the pitch angle is minimized due to the effect of the first linkage 165 or second linkage 166. Thus, a lift at a left of the drone is minimized.

In this connection, the right at the left of the rotary wing drone 100 is maximized while a lift at the left of the drone is minimized, such that the rotary wing drone 100 may perform the leftwards flight.

FIG. 15 illustrates one example where the top cover performs a switch function in a rotary wing drone according to one embodiment of the present disclosure.

The top cover 210 and the first fixed casing 221 may be combined with each other via a plurality of rotatable hooks 211. The first fixed casing 211 may include a plurality of switches.

The rotatable hook 211 may include a hook protrusion 211a and a hook receiving groove 211b. The hook protrusion 211a may be provided on the top cover 210, while the hook receiving groove 211b may be defined in the first fixed casing 211. The hook receiving groove may receive a switch 212.

The hook protrusion 211a is rotated and inserted into the hook receiving groove 211b, thereby joining the top cover 210 and the first fixed casing 221 with each other. In this case, the hook protrusion 211a may be positioned on the switch 212.

When the hook protrusion 211a is positioned on the switch 212, the switch 212 may be in the OFF state. However, when the user presses the top cover 210, the hook protrusion 211a may move in a downward direction. As the hook protrusion 211a moves in the downward direction, the switch 212 may be turned on.

According to one embodiment, when the plurality of switches are pressed for a pre-set time, for example, 3 seconds at a state in which the power of the rotary wing drone 100 is turned off, the rotary wing drone 100 may be powered on. When the rotary wing drone 100 is powered on, the first motor 710 and second motor 720 may work.

According to another embodiment, when the plurality of switches are pressed during the pre-set time in a state in which the power of the rotary wing drone 100 is turned on, the power of the rotary wing drone 100 may be turned off. When the rotary wing drone 100 is powered off, the first motor 710 and second motor 720 may be disabled.

According to the present embodiment, when the top cover 210 itself performs the switch function, the size of the switch increases such that accessibility thereto may be improved from the viewpoint of the user. Further, the rotary wing drone 100 does not require a separate switch on the outside of the drone 100.

At least one of the embodiments of the present disclosure as described above has the advantage that the structure of the rotary wing drone is simplified, and has the effect of reducing the noise of the rotary wing drone. Further, there is an advantage that the maintenance of the rotary wing drone using the coaxial inverted rotor is easy and the maintenance cost is low.

The above-described embodiments are only preferred examples of the present disclosure. The technical idea of the present disclosure may be variously adapted or modified by those skilled in the art. Such variations or adaptions fall within the scope of the present disclosure.

### Various Modes

Various embodiments have been described in the best mode for carrying out the invention.

### INDUSTRIAL AVAILABILITY

The present invention is used in the field related to drones using coaxial inverting rotors.

It will be apparent to those skilled in the art that various modifications and variations may be made in the present invention without departing from the spirit or scope of the invention. Accordingly, it is intended that the present invention cover the modifications and variations of this invention provided they come within the scope of the appended claims and their equivalents.

What is claimed is:

1. A rotary wing drone comprising:
a flight controller configured to control flight of the rotary wing drone;
a main body for receiving a first motor and a second motor therein;
an upper shaft vertically inserted into the main body, wherein the upper shaft rotates in a first direction about a first axis using a rotation force from the first motor;
a plurality of upper rotor blades coupled to the upper shaft to rotate in the first direction about the first axis at a fixed pitch angle;
a lower shaft vertically inserted into the main body, wherein the lower shaft rotates in a second direction opposite to the first direction about the first axis using a rotation force from the second motor;
a plurality of lower rotor blades coupled the lower shaft to rotate in the second direction about the first axis at a varying pitch angle; and
a pitch control mechanism including a swash plate, tilt adjusters for adjusting a tilt of the swash plate, and linkages for connecting the swash plate and the plurality of lower rotor blades with each other respectively, wherein the pitch control mechanism is disposed below the lower rotor blades.

2. The rotary wing drone of claim 1, wherein a rotation axis of each of the first motor and the second motor defines the first axis.

3. The rotary wing drone of claim 2, wherein each of the first motor and the second motor includes a brushless direct current (DC) motor with a hollow shaft, and is positioned between the first shaft and the second shaft,
wherein the upper shaft is coupled directly to the first motor, and the lower shaft is connected directly to the second motor.

4. The rotary wing drone of claim 1, wherein when the flight controller detects an ascending flight command while both the first motor and the second motor rotate at a first rotation speed, the flight controller is configured to control the first motor and the second motor so that a rotation speed of each of the first motor and the second motor is greater than the first rotation speed,
wherein in response to the ascending flight command, the flight controller is configured to control the tilt adjusters such that a top face of the swash plate is oriented to be perpendicular to a direction of the first axis.

5. The rotary wing drone of claim 1, wherein when the flight controller detects an descending flight command while both the first motor and the second motor rotate at a first rotation speed, the flight controller is configured to control the first motor and the second motor so that a rotation speed of each of the first motor and the second motor is lower than the first rotation speed,
wherein in response to the descending flight command, the flight controller is configured to control the tilt adjusters such that a top face of the swash plate is oriented to be perpendicular to a direction of the first axis.

6. The rotary wing drone of claim 1, wherein when the flight controller detects a flight command to instruct the drone to rotate in the first direction while both the first motor and the second motor rotate at a first rotation speed, the flight controller is configured to control the first motor and the second motor so that a rotation speed of the first motor is lower than the first rotation speed while a rotation speed of the second motor is greater than the first rotation speed,
wherein in response to the flight command, the flight controller is configured to control the tilt adjusters such that a top face of the swash plate is oriented to be perpendicular to a direction of the first axis.

7. The rotary wing drone of claim 1, wherein when the flight controller detects a flight command to instruct the drone to rotate in the second direction while both the first motor and the second motor rotate at a first rotation speed, the flight controller is configured to control the first motor and the second motor so that a rotation speed of the first motor is higher than the first rotation speed while a rotation speed of the second motor is lower than the first rotation speed,
wherein in response to the flight command, the flight controller is configured to control the tilt adjusters such that a top face of the swash plate is oriented to be perpendicular to a direction of the first axis.

8. The rotary wing drone of claim 1, wherein when the flight controller detects a horizontal movement flight command, the flight controller is configured to control the tilt adjusters so that the swash plate is tilted, and to control the first motor and the second motor to maintain current rotation speeds thereof.

9. The rotary wing drone of claim 8, wherein when the second direction is a counterclockwise direction, the flight controller is configured to control the tilt adjusters so that the swash plate is tilted so that the top face of the swash plate is tilted in a left direction with respect to a direction corresponding to the flight command.

10. The rotary wing drone of claim 8, wherein when the second direction is a clockwise direction, the flight controller is configured to control the tilt adjusters so that the swash plate is tilted so that the top face of the swash plate is tilted in a right direction with respect to a direction corresponding to the flight command.
